(19) United States
(12) Patent Application Publication
(10) Pub. No.: US 2024/0400306 A1
(43) Pub. Date: Dec. 5, 2024

(54) ORDER PICKING SYSTEM

(71) Applicant: FERAG AG, CH-8340 HINWIL (CH)

(72) Inventors: Marc-Andreas BENZ, Hinwil (CH); Roberto FENILE, Hinwil (CH)

(73) Assignee: FERAG AG, CH-8340 HINWIL (CH)

(21) Appl. No.: 18/678,617

(22) Filed: May 30, 2024

(30) Foreign Application Priority Data
May 31, 2023 (CH) 000578/2023

(51) Int. Cl. B65G 1/137; B65B 35/50; B65G 61/00

(52) U.S. Cl. CPC B65G 1/1376; B65B 35/50; B65G 61/00

(57) ABSTRACT

An order picking system (1) for the transportation and stacked provision of piece good (W) includes a feeding device (2) with a suspension conveyor (2.1) for providing the piece good (W) and a delivery station (2.2) for discharging the piece good (W) from the suspension conveyor (2.1) to a stacking device (3) for stacking the conveyed piece good (W), wherein the piece good (W) is stacked vertically on a stacking spot (3.1) by the stacking device (3).

### CROSS-REFERENCE TO RELATED APPLICATIONS

Swiss Patent Application Nos. CH 000578/2023, filed 31 May 2023, the priority document corresponding to this invention, to which a foreign priority benefit is claimed under Title 35, United States Code, Section 119, and its entire teachings are incorporated, by reference, into this specification.

### FIELD OF THE DISCLOSURE

The present disclosure relates to an order picking system with a stacking device for vertically stacking piece goods.

### BACKGROUND OF THE DISCLOSURE

The following order picking systems, among others, are known from the prior art.

EP 4001188 A1, published on 25 May 2022 in the name of Siemens AG, discloses an end point device for a sorting system for sorting piece goods, comprising a receiving device, a transport device and a row arrangement of end points arranged in a row, wherein the receiving device is designed to receive a piece good from a sorter outlet of a sorter of the sorting system and to deliver it to the transport device, wherein the transport device comprises a transport unit which is movable to each of the end points arranged in the row and wherein the transport device is designed to take over the piece goods delivered by the receiving device and to transport it with the transport unit to a desired end point of the end points arranged in the row and to deliver it to this desired end point.

EP 1253098 A1, published on 30 Oct. 2002 on behalf of Grapha Holding, discloses a device for processing printed products fed to a stacking device, which are picked up at a delivery of a printing press or a print processing machine by a conveyor device for suspended further transport and are fed via a conveyor path to a transfer device connected upstream of the stacking device. The stacking device is designed as a unit which can be detached from the transfer device and can optionally be connected to the transfer device which is connected to the printing press or the print processing machine so as to be effective for conveying.

DE 20019292 U1, published on 29 Mar. 2001 in the name of PSB GmbH, discloses a device for sorting and stacking piece goods, which comprises a controllable feed conveyor for the sorted piece goods, a distribution device with a plurality of movable piece good receptacles rotating in a circle about a central axis, devices for the controlled discharge of the sorted piece goods from the piece good receptacle, a target point for forming a stack of sorted piece goods, wherein the feed conveyor transfers the goods to be sorted approximately tangentially to the goods receptacles, which are realized as a controllable conveying device and the target points are located under the goods receptacles, wherein a controllable deposit is located between the goods receptacles and each target point, wherein the goods receptacles discharge the goods to be sorted onto a respective deposit by conveying the goods to be sorted against the direction of rotation.

### SUMMARY OF THE DISCLOSURE

In the area of picking piece goods, especially in business-to-customer (B2C) order picking, it is necessary to be able to process various types of piece goods in one and the same system. The aim is to be able to provide ready-to-ship orders on the outbound side of the order picking system. Typically, the goods are dispatched in fixed containers such as cardboard boxes. The customer order should therefore be prepared for packaging on the outbound side of the order picking system in as little space as possible.

While there are fewer orders in the business-to-business (B2B) area but with large volumes and the same product sequences, as companies typically request products in large quantities, there are typically many individual orders in the business-to-customer (B2C) area with individual deliveries of goods or small volumes and small quantities, which can also exhibit high seasonal fluctuations.

Piece goods can be a very wide range of products. For example, both inherently stable products, such as parcels, boxes or books, as well as flexible and essentially flat piece goods, such as magazines or even individual loose items of clothing packaged only with a flexible protective cover, must be picked at the same time.

One objective of the disclosure can be seen in providing an order picking system that enables the space-saving provision of consignments of goods with a wide variety of product categories.

An order picking system according to the disclosure is used for transporting and stacked provision of piece goods. The order picking system typically comprises a feeding device and a stacking device. Piece goods can be a very wide range of products. For example, inherently stable products such as packages, boxes or books are possible. On the other hand, however, flexible and essentially flat piece goods such as magazines or even items of clothing can also be stacked. In the context of this disclosure, stacking or piling up is to be understood as the preferably vertical stacking of loosely arranged piece goods on top of one another. A stack is to be understood here as a pile or heap, preferably neatly stacked, comprising a plurality of piece goods. The cargo can be stacked on top of each other without a fixed orientation, thus forming the stack.

The feeding device comprises a suspension conveyor for providing the piece goods and a delivery station for delivering the piece goods from the suspension conveyor to the stacking device. The piece good is preferably delivered to the delivery station suspended in suspended bags and emptied by means of the delivery station and transferred to the stacking device located downstream. The suspension conveyor typically comprises at least one rail on which the suspended bags can be conveyed suspended by means of carriages. Alternatively, the suspension conveyor can also comprise baskets, bags or carrying loops by means of which the piece goods can be conveyed suspended.

The suspended bags may comprise a rear wall and a front wall, which are flexibly connected to each other via a base section in such a way that they can be moved back and forth between a first state, in which they form an open and fillable bag, and a second state, in which they lie close together and form a folded bag.

The suspension conveyor can connect to the feeding device, which preferably comprises a delivery station in the form of a discharge device. The suspension conveyor or even several suspension conveyors can connect the stacking device with upstream devices. The suspension conveyor can be used to connect a delivery with a removal within a logistics system and thus establish the flow of goods.

The discharge device can comprise a circulating conveyor belt for transferring piece goods transported in the suspended bags. At a contact section, the conveying path of the suspension conveyor and the conveying path of the conveyor belt can be arranged relative to each other in such a way that the distance between the conveying path of the suspension conveyor and the conveying path of the conveyor belt becomes continuously smaller, so that when a suspended bag is conveyed along the contact section, a front side of the suspended bag contacts the conveyor belt and comes to rest on it and the suspended bag is pivoted backwards.

In a transfer section, the conveying path of the suspension conveyor and the conveying path of the conveyor belt can run essentially parallel to one another with a certain downward slope, with the front of the respective suspended bag continuing to lie on the conveyor belt during conveying along the transfer section, so that the opening of the suspended bag is oriented obliquely downwards and piece good present in the suspended bag slides out of the bag, preferably gravity-driven, onto the conveyor belt.

In a separating section, the distance between the conveying path of the suspension conveyor and the conveying path of the conveyor belt can become continuously greater, so that when a suspended bag is conveyed along the separating section, the emptied suspended bag is lifted off the conveyor belt and swings back into the free-hanging position. The conveying speeds of the conveyor belt and the suspension conveyor are usually the same.

The conveyor belt can comprise a plurality of outwardly directed transverse ribs that are evenly spaced along a circumference of the conveyor belt. The relative position of the ribs and the suspended bags are typically selected so that in the contact section, a rib catches up with the suspended bag, contacts the bottom section of the suspended bag and pushes it forward in the conveying direction until the suspended bag has been transitioned to an emptying state. In the contact section, in the area where the respective rib touches the bottom section of the suspended bag, the suspension conveyor and the conveyor belt can be operated at the same speed. In particular, the suspension conveyor and the conveyor belt can run constantly at the same speed.

The spacing of the ribs can be selected so that during the conveying of a suspended bag along the transfer section, any piece good present in the suspended bag slides out of the bag onto the conveyor belt driven by gravity and continues to slide downwards on the conveyor belt assisted by gravity until it is caught and held by the rib running ahead of the suspended bag. The ribs of the conveyor belt can comprise of a large number of parallel fingers.

An upper end of the slide can comprise slots whose position corresponds to the fingers of the ribs of the conveyor belt, so that when the conveyor belt is deflected, the fingers of the ribs and the slots of the slide interact with each other in a meshing manner and piece good held back behind a rib is released in a timed manner, which is then conveyed further on the slide by gravity. Another conveyor can take over the released piece goods from the slide.

In addition, vibration means can be provided with which the surface of the conveyor belt can be made to vibrate or oscillate in at least one section of the conveyor belt.

Discharge devices such as those disclosed in the applicant's WO 2018142243 in the claimed invention can also be used in the order picking system, which are hereby incorporated.

The suspended bags can be emptied by means of the delivery station and the piece goods can be transferred either directly to the stacking device or to a feeding conveyor and to the stacking device by means of the feeding conveyor. While inherently stable piece good is essentially transported upright in the suspended bag during transportation, flexible piece good is transported in a folded manner, both is transferred horizontally by the delivery station.

In this context, the term horizontal refers to an essentially horizontal orientation of the piece goods, in which the piece goods come to rest with its base side in a horizontal position on the feeding conveyor or stacking device.

In order to prevent piece good delivered by the delivery station from being moved beyond the stacking device, the latter may comprise a stop. The stacking device can comprise a stop for positioning the piece goods delivered by the delivery device. This can be designed, for example, as a guide plate or bracket that deflects the piece good and positions it on the delivery station.

A feeding conveyor optionally arranged between the delivery station and the stacking device can be operated in stop-and-go mode and/or accelerated or decelerated in order to be able to transfer the respective piece good to the stacking device one by one. The feeding conveyor can be a telescopic belt with a movable end. The movable end can be used to transfer the piece good to the center of the stacking device. In order to be able to determine the center of the piece good, especially in the case of piece good that has an asymmetrical layout and/or is delivered to the feeding conveyor in an unsorted manner, the position on the feeding conveyor can be determined by means of a sensor, preferably an optical sensor, in order to be able to transfer the piece good to the center of the stacking device.

The conveyed piece good can be stacked vertically on a stacking spot by means of the stacking device. The stacking spot can take the form of a physical spot, for example a stacking spot on the floor or on a pallet. Alternatively, the stacking spot can also be a virtual stacking spot in the form of a belt section or a conveyor unit such as a conveyor tray. The stacking device can for example comprise a delivery conveyor, with the stacking spot being arranged on the delivery conveyor so that the stack can be delivered by means of the delivery conveyor. The delivery conveyor can be a roller, belt or tray conveyor.

The delivery device is typically vertically offset, arranged above the stacking spot and the piece good can be transferred to form a free stack. The stacking device can comprise a lifting device, which is arranged below the delivery device and can be moved vertically in the direction of the stacking spot or the conveyor. Once a piece of piece good has been transferred from the stacking device to the lifting device, it is typically moved further before the next piece of piece goods is transferred. The lifting device can, for example, be designed as a lifting table with a fixed plate that can be moved in a vertical direction. To facilitate the delivery of the finished stack, the lifting device can also comprise a conveyor belt instead of the plate.

In order to be able to transfer the piece goods to the stacking spot in a separated and controlled manner, the stacking device can comprise at least one delivery device, by means of which one piece good at a time can be released and transferred to the stacking spot by gravity to form a stack. In addition to transferring piece good to a free stacking spot or to a pallet, the piece good can also be stacked directly into a transport container, such as boxes, sacks or cartons.

To ensure that the stack is stacked as vertically and stably as possible, the aim is usually to deliver the piece good to the stacking spot as centrally as possible. For this purpose, the delivery device can comprise at least one delivery element that can be moved or pivoted so that the respective piece good can be transferred to the stacking spot by means of the delivery element.

The delivery device can also comprise two or more delivery elements, which are preferably symmetrically movable or pivotable. These can be designed as sliders that can be moved horizontally. This generates a gap through which the piece good can be transferred gravity-driven to the stacking spot. Alternatively, the two delivery elements can be designed as flaps whose opposite ends can be pivoted in the direction of the stacking spot. Pivoting in the direction of the stacking spot results in a funnel-shaped dispensing surface by which the piece good is centered and can thus be transferred centrally. In one embodiment, the delivery device comprises four essentially triangular flaps, which form a funnel when being pivoted in order to align and center the piece good during transfer.

In a further embodiment, the two delivery elements can be designed as transverse conveyors, which can be driven and accelerated or decelerated and can be moved horizontally, preferably in opposite directions, along a conveying direction. The transverse conveyors can each comprise a movable end and a stationary end, and by moving the movable ends in opposite directions along the conveying direction, a gap can be generated through which a piece of piece good can be discharged onto the stacking spot. When the movable ends are moved together, a gap remains. However, this gap is so small that none of the piece good to be conveyed can fall through it. To transfer a piece of piece good, a gap of such a size can be generated that exactly the piece good to be transferred can be transferred through the gap to the stacking spot or stack.

The transverse conveyors can be used to move or align the respective piece good. In one embodiment, the delivery conveyor can comprise at least two delivery lines and the movable ends of the transverse conveyors can each be moved along the conveying direction in such a way that the gap is positioned and generated above a stacking spot on one of the at least two delivery lines. In this way, the piece good on the transverse conveyors can be positioned above one of the two delivery lines and the gap can be adjusted by moving the movable ends of the transverse conveyors in opposite directions so that the piece good can be transferred to one of the two delivery lines.

The order picking system can comprise a measuring device for measuring the height of the stack and/or for detecting whether there is piece good on the delivery device. On the one hand, this can be used to determine when the target or maximum height of the stack has been reached and the stack can be transported away. On the other hand, the delivery device can be controlled using the measuring data recorded by the measuring device.

Alternatively, or additionally, the order picking system can comprise a monitoring device by means of which the layout of the stack can be monitored in a top view and/or the outline of the stack can be monitored in a side view. This ensures that stacks that are becoming unstable can be detected and recognized at an early stage. The layout is to be understood as the outline of the stack as seen from above. This can also be used to detect stacks whose layout would exceed the permissible dimensions of downstream devices and can therefore be rejected at an early stage.

By monitoring at least two orthogonally related side surfaces of the stack, the vertical alignment of the stack can also be monitored. In addition to maintaining the maximum dimensions of the layout of the stack, the stack should not usually exceed a certain degree of lateral runout in order not to become too unstable.

The monitoring device can determine measurement data by means of at least one sensor, preferably an optical sensor, when stacking and/or when the stack moves past the sensor. For example, an imaging sensor, a laser raster or a light barrier can be used to monitor the layout. An optical proximity sensor can be used to monitor the side impact.

A method according to the disclosure for transporting and providing piece good in a stacked manner, comprises at least the following method steps:
providing a feeding device comprising a suspension conveyor and a delivery station, and providing a stacking device;
providing the piece good by means of the suspension conveyor and delivering the piece good from the suspension conveyor to the stacking device by the delivery station; and
stacking the conveyed piece good by the stacking device on the stacking spot.

The stacking device can comprise at least one delivery device by means of which one piece of piece good at a time is released and gravity-driven transferred to the stacking spot to form a stack.

The at least one delivery device can comprise two delivery elements which are moved or pivoted, preferably folded, in order to transfer the respective piece good to the stacking spot.

### BRIEF DESCRIPTION OF THE DRAWINGS

Aspects of the disclosure are explained in more detail with reference to the embodiments shown in the following figures and the associated description.

FIG. 1A, a first embodiment of the order picking system, shows the feeding conveyor of the piece good.

FIG. 1B, the first embodiment of the order picking system, shows the transfer of the piece good to the stacking device.

FIG. 1C, the first embodiment of the order picking system, shows the stacking of the piece good by means of the stacking device.

FIG. 2A, a second embodiment of the order picking system, shows the feeding conveyor of the piece good.

FIG. 2B, the second embodiment of the order picking system, shows the transfer of the piece good to the stacking device.

FIG. 2C, the second embodiment of the order picking system, shows the stacking of the piece good by means of the stacking device.

FIG. 3A, a third embodiment of the order picking system, shows the feeding conveyor of the piece good.

FIG. 3B, the third embodiment of the order picking system, shows the transfer of the piece good to the stacking device.

FIG. 3C, the third embodiment of the order picking system, shows the stacking of the piece good by means of the stacking device.

FIG. 4 a fourth embodiment of the order picking system.

FIG. 5A, a fifth embodiment of the order picking system, shows the feeding conveyor of the piece good.

FIG. 5B, the fifth embodiment of the order picking system, shows the provision of the piece good via a conveyor line.

FIG. 5C, the fifth embodiment of the order picking system, shows the stacking of the piece good by means of the stacking device.

### DESCRIPTION OF THE EMBODIMENTS

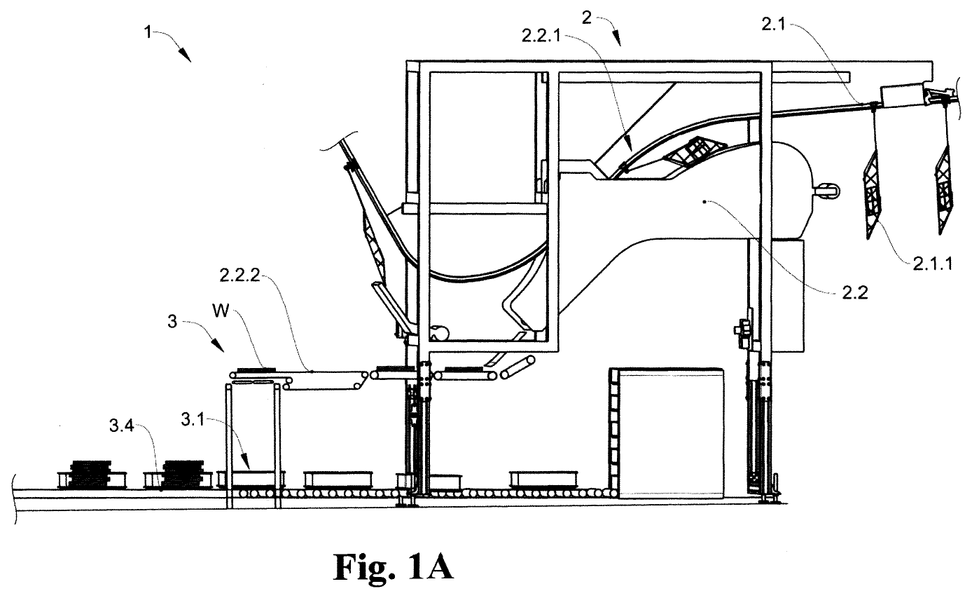

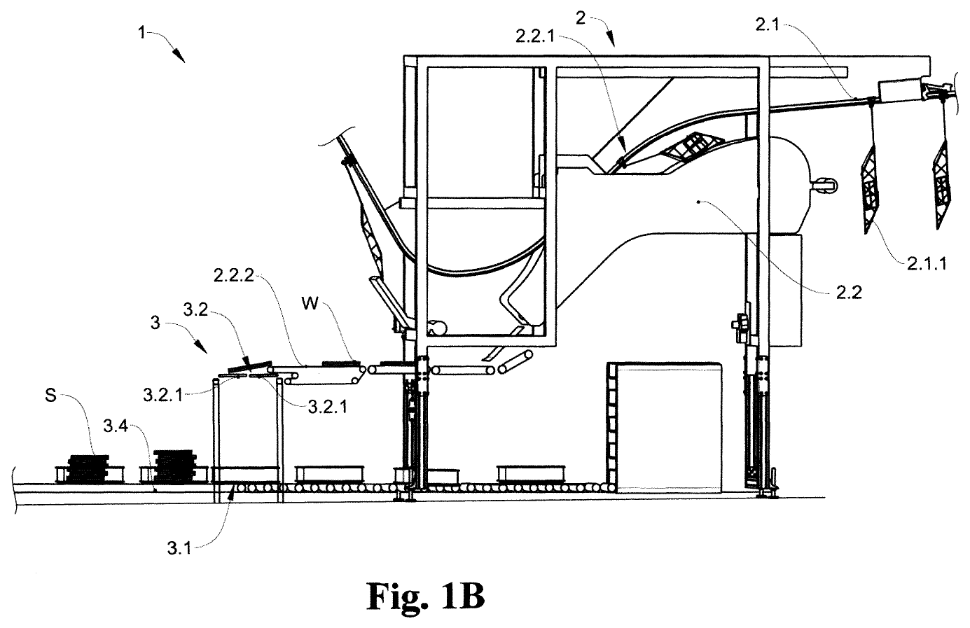

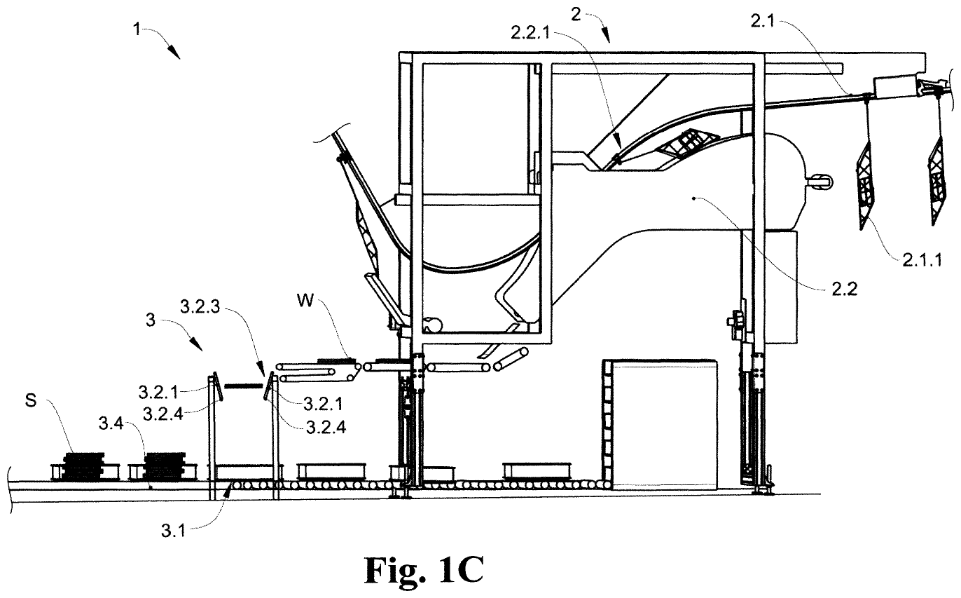

FIGS. 1A to 1C show a first embodiment of the order picking system 1 for transporting and stacking piece good W.

FIG. 1A shows the order picking system 1 with a feeding device 2 for providing the piece good W, which comprises a suspension conveyor 2.1 for this purpose. The suspension conveyor 2.1 shown comprises suspended bags 2.1.1 for providing the piece good W. Alternatively, the suspension conveyor 2.1 can also comprise baskets, bags or carrying loops, by means of which the piece good W can be conveyed suspended.

For emptying and discharging the piece good W, the feeding device 2 shown further comprises a delivery station 2.2 for discharging the piece good W from the suspension conveyor 2.1. The delivery station 2.2 of the feeding device 2 shown is designed as a discharge device 2.2.1. The piece good W delivered from the discharge device 2.2.1 to the stacking device 3 by means of a telescopic belt 2.2.2 can be stacked by means of the latter. In the shown embodiment, the piece good W is stacked vertically onto a stacking spot 3.1 on a delivery conveyor 3.4 by means of the stacking device 3.

FIG. 1B shows the transfer of the piece good W to the stacking device 3. The delivery device 3.2 shown is vertically offset, arranged above the stacking spot 3.1 and transfers the piece good W to form a free stack S. In the embodiment shown, the piece good W is transferred to the center of the stacking device 3 by means of the telescopic belt 2.2.2.

The stacking device 3 shown comprises a delivery device 3.2, by means of which one piece of piece good W can be released after the other and transferred by gravity to form a stack S on the stacking spot 3.1. The shown delivery device 3.2 comprises two delivery elements 3.2.1, which are pivotably arranged, in the embodiment shown symmetrically pivotable, so that the respective piece good W can be transferred to the stacking spot 3.1 by means of the two delivery elements 3.2.1 and the stacked stack S can be conveyed away by means of the discharge conveyor 3.4.

FIG. 1C shows the stacking of the piece good W by means of the stacking device 3. The two delivery elements 3.2.1 shown, which are designed as flaps 3.2.3, the opposite ends 3.2.4 of which are pivotable in the direction of the stacking spot 3.1 and are pivoted to release the piece good W.

Alternatively, the two delivery elements 3.2.1 can also be designed as sliders 3.2.2, which can be moved horizontally to release the piece good W. Pivoting in the direction of the stacking spot 3.1 results in a funnel-shaped discharge surface, as can be seen in the figure, over which the piece good W is centered and can thus be transferred centrally. The stacking device 3 shown comprises a delivery conveyor 3.4, so that the stack S can be delivered by means of the delivery conveyor 3.4. The delivery conveyor 3.4 shown is a roller conveyor, but can also be a belt or tray conveyor.

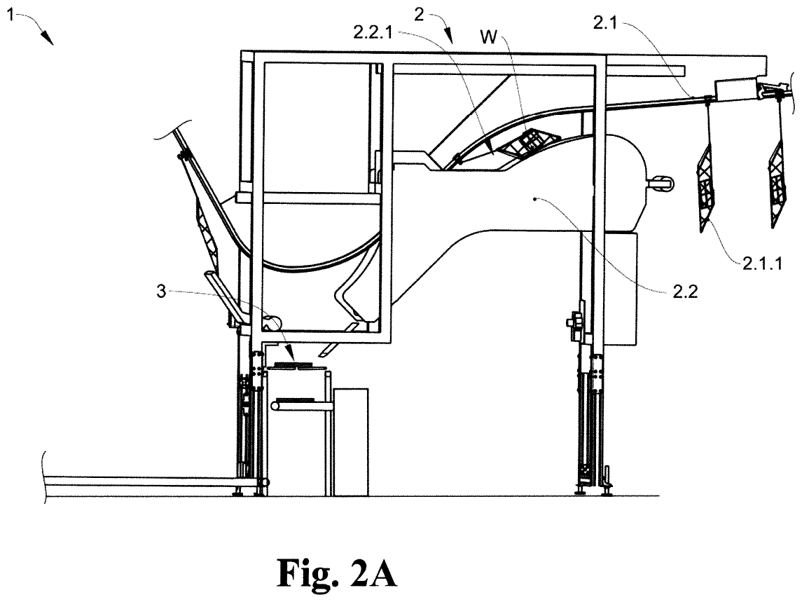

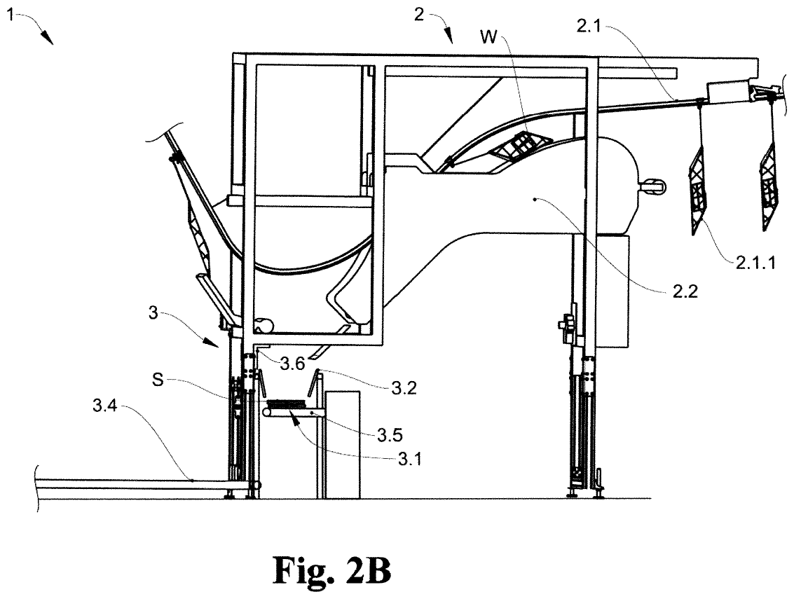

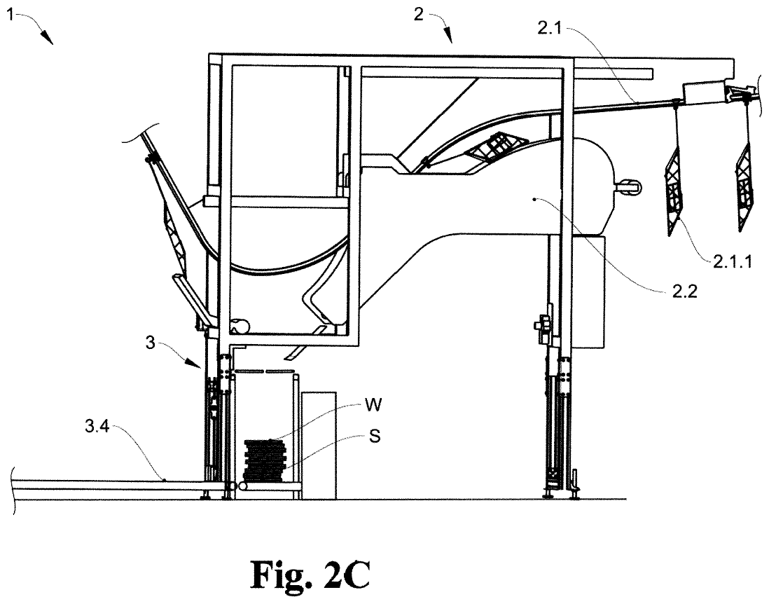

FIGS. 2A to 2C show a second embodiment of the order picking system 1 with a lifting device 3.5.

FIG. 2A shows the provision of the piece good W. For emptying and discharging the piece good W, the feeding device 2 shown also comprises a delivery station 2.2 for discharging the piece good W from the suspended bags 2.1.1 of the suspension conveyor 2.1. The discharge device 2.2.1, however, transfers the piece good W directly to the stacking device 3.1 piece good. In contrast to the first embodiment, the discharge device 2.2.1 of the embodiment shown is not connected to the stacking device 3 by means of a telescopic belt, but transfers the piece good W directly to the stacking device 3.

FIG. 2B shows the transfer of the piece good W to the stacking device 3. The delivery device 3.2 shown is vertically offset, arranged above the stacking spot 3.1 and transfers the piece good W to the lifting device 3.5 to form a stack S. The stacking device 3 shown comprises a lifting device 3.5, which is arranged below the delivery device 3.2 and can be moved vertically in the direction of the conveyor 3.4. Furthermore, the stacking device 3 comprises a stop 3.6 for positioning the piece good W delivered by the delivery device 3.2. After a piece of piece good W has been delivered from the stacking device 3 to the lifting device 3.5, the latter is typically moved further before the next piece of piece good W is transferred.

FIG. 2C shows the stacking of the piece good W by means of the stacking device 3. The stacking device 3 shown comprises a delivery conveyor 3.4, so that the stack S can be delivered by means of the delivery conveyor 3.4. The delivery conveyor 3.4 shown is a belt conveyor, but can also be a roller, plate or tray conveyor, for example.

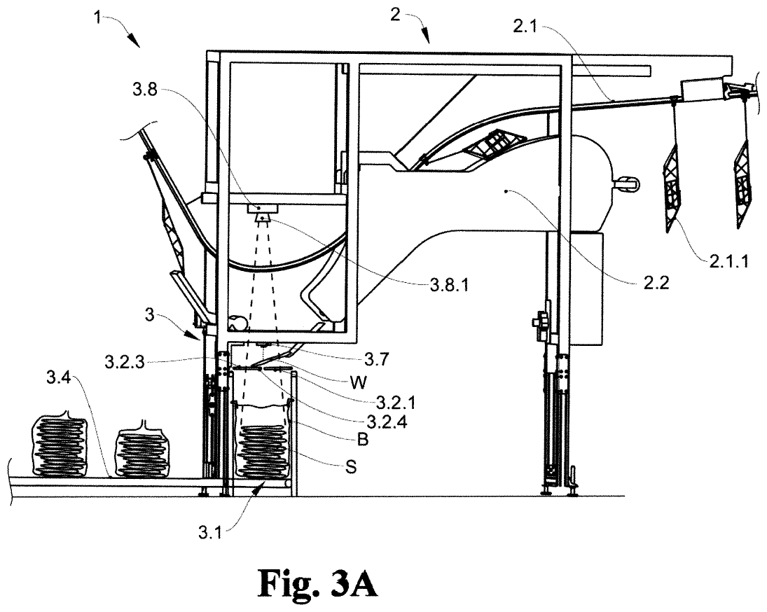

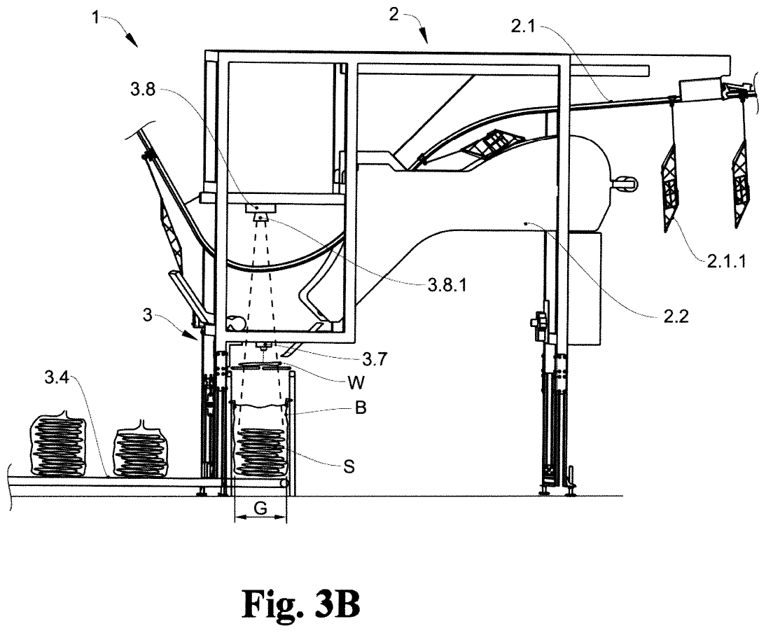

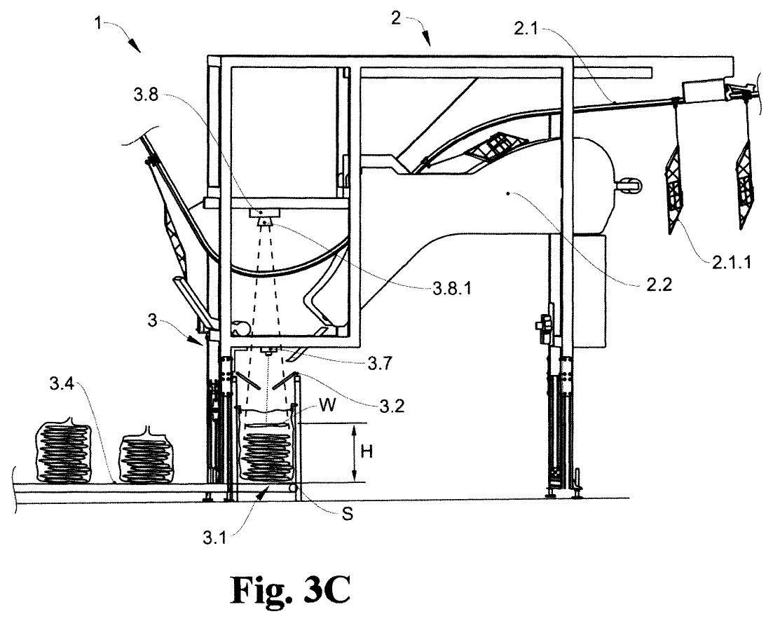

FIGS. 3A to 3C show a third embodiment of the order picking system 1 with a measuring device 3.7.

FIG. 3A shows the feeding conveyor of the piece good W. The two delivery elements 3.2.1 shown are also designed as flaps 3.2.3, whose opposite ends 3.2.4 can be pivoted in the direction of the stacking spot 3.1 in order to release the piece good W. Alternatively, the two delivery elements 3.2.1 can also be designed as sliders, which can be moved horizontally to release the piece good W. The order picking system 1 shown comprises a measuring device 3.7 and a monitoring device 3.8 with a sensor 3.8.1. The measuring device 3.7 can be used to detect whether a piece of piece good W is on the delivery device 3.2.

FIG. 3B shows the transfer of the piece good W to the stacking device 3. In the embodiment shown, the piece good W is picked into bags B. In addition to the measuring device 3.7, the order picking system 3 shown comprises a monitoring device 3.8, by means of which the layout G of the stack S can be monitored in a top view and/or the outline of the stack S can be monitored in a side view. The monitoring device 3.8 can determine the measurement data by means of the sensor 3.8.1, preferably an optical sensor, when stacking and/or when the stack S moves past the sensor 3.8.1.

FIG. 3C shows the stacking of the piece good W using the stacking device 3. The height H of the stack S can be detected using the measuring device 3.7 shown. On the one hand, this can be used to determine when the target or maximum height of the stack S has been reached and the stack S is to be transported away. On the other hand, the delivery device 3.2 can be controlled by means of the measuring data recorded by the measuring device 3.7.

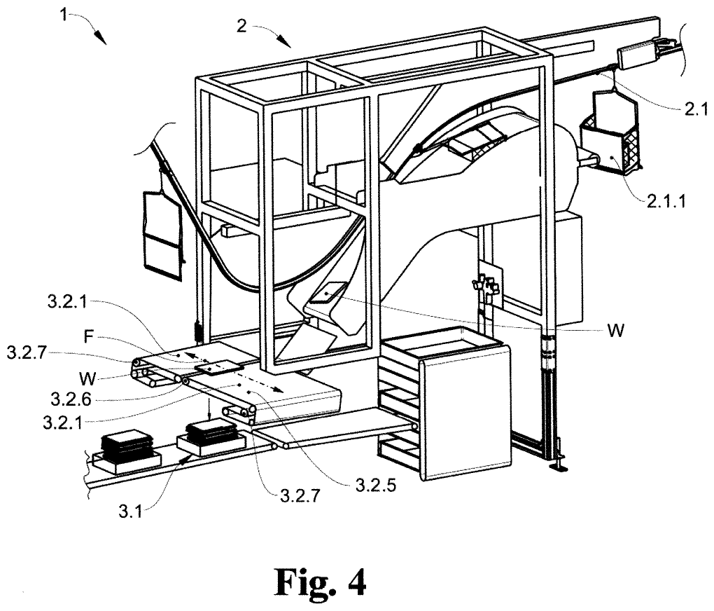

FIG. 4 shows a fourth embodiment of the order picking system 1. In this embodiment, the two delivery elements 3.2.1 are designed as transverse conveyors 3.2.5, which can be driven and accelerated or decelerated and can be moved horizontally, preferably in opposite directions, along a conveying direction F. The transverse conveyors 3.2.5 each comprise a movable end 3.2.6 and a stationary end 3.2.7 and by moving the movable ends 3.2.6 in opposite directions along the conveying direction F, a gap can be generated through which a piece good W can be discharged onto the stacking spot 3.1. The transverse conveyors 3.2.5 can be used to move or align the respective piece good W.

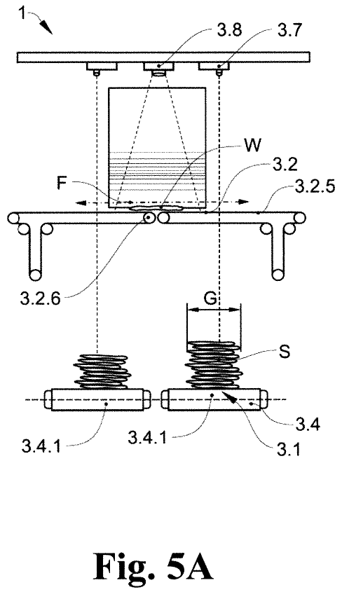

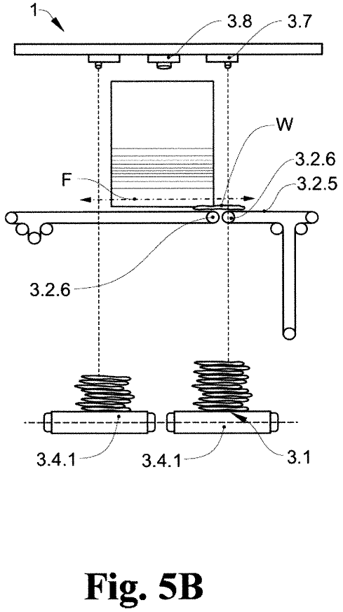

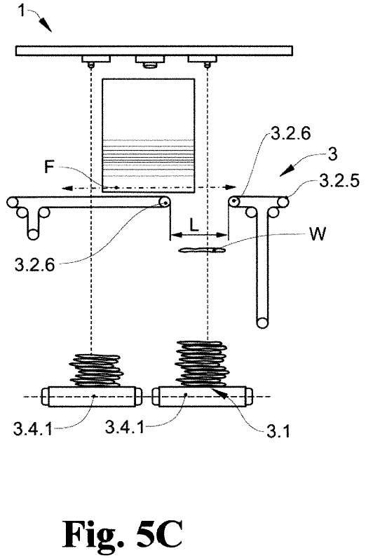

FIGS. 5A to 5C show a fifth embodiment of the order picking system 1.

FIG. 5A shows the delivery of the piece good W. The delivery conveyor 3.4 of the order picking system 1 shown comprises two delivery lines 3.4.1, whereby the movable ends 3.2.6 of the transverse conveyors 3.2.5 can each be moved along the conveying direction F in such a way that the gap above a stacking spot 3.1 can be generated on one of the two delivery lines 3.4.1.

The order picking system 1 comprises a measuring device 3.7 for measuring the height of the stack S and for detecting whether a piece of piece good W is on the delivery device 3.2. In addition to determining when the target or maximum height of the stack S has been reached and the stack S can be transported away, the exact position of the piece good W on the transverse conveyors 3.2.5 can also be determined. The monitoring device 3.8 can be used to monitor the layout of the stack G in a top view and/or the outline U of the stack S in a side view.

FIG. 5B shows the provision of the piece good W above one of the delivery lines 3.4.1. The movable ends 3.2.6 of the transverse conveyors 3.2.5 are each moved along the conveying direction F in such a way that the piece good W is positioned above a stacking spot 3.1 and is transferred to one of the at least two delivery lines 3.4.1 by generating the gap. The transverse conveyors 3.2.5 thus act as a distribution device, whereby the piece good W conveyed via the delivery station can be divided between the two conveyor lines 3.4.1.

FIG. 5C shows the stacking of the piece good W by means of the stacking device 3. To transfer the piece good W to one of the two delivery lines 3.4.1, the movable ends 3.2.6 of the transverse conveyors 3.2.5 are each moved along the conveying direction F so that the gap L above a stacking spot 3.1 on one of the at least two delivery lines 3.4.1 can be positioned and generated.

1. An order picking system (1) for the transportation and stacked provision of piece goods (W) comprising:
a. a feeding device (2) comprising a suspension conveyor (2.1) configured for providing the piece goods (W) and a delivery station (2.2) configured for delivering the piece goods (W) from the suspension conveyor (2.1) to
b. a stacking device (3) configured for stacking the conveyed piece goods (W), wherein the piece goods (W) are stacked vertically on a stacking spot (3.1) by the stacking device (3).

2. The order picking system (1) according to claim 1, wherein the stacking device (3) comprises at least one delivery device (3.2) configured to release and transfer one piece of piece good (W) after the other by gravity to the stacking spot (3.1) to form a stack(S) of piece good (W).

3. The order picking system (1) according to claim 2, wherein the at least one delivery device (3.2) comprises at least one delivery element (3.2.1) which is at least one of the following: movably arranged, pivotable, and displaceable.

4. The order picking system (1) according to claim 2, wherein the at least one delivery device (3.2) comprises two delivery elements (3.2.1) which are arranged to be at least one of the following: movable, pivotable, symmetrically movable, and symmetrically pivotable, so that the respective piece good (W) is transferred to the stacking spot (3.1) by the two delivery elements (3.2.1).

5. The order picking system (1) according to claim 4, wherein the two delivery elements (3.2.1) are designed as sliders (3.2.2) which are configured to be moved horizontally or are designed as flaps (3.2.3) whose opposite ends (3.2.4) are configured to be pivoted in the direction of the stacking spot (3.1).

6. The order picking system (1) according to claim 4, wherein the two delivery elements (3.2.1) are designed as transverse conveyors (3.2.5) which are configured to be driven and accelerated or decelerated and are configured to be moved at least one of horizontally moved, moved in opposite directions, and moved along a conveying direction (F).

7. The order picking system (1) according to claim 6, wherein the transverse conveyors (3.2.5) each comprise a movable end (3.2.6) and a stationary end (3.2.7) and are configured by moving the movable ends (3.2.6) in opposite directions along the conveying direction (F) to position and generate a gap (L), through which a piece of piece good (W) is adapted to be discharged onto the stacking spot (3.1).

8. The order picking system (1) according to claim 1, wherein the stacking device (3) further comprises a delivery conveyor (3.4) and the stacking spot (3.1) is arranged on the delivery conveyor (3.4), with the delivery conveyor (3.4) configured to deliver the stack(S).

9. The order picking system (1) according to claim 8, wherein the delivery conveyor (3.4) comprises at least two delivery lines (3.4.1) and the movable ends (3.2.6) of the transverse conveyors (3.2.5) are configured to be moved along the conveying direction (F) in such a way that the gap (L) above a stacking spot (3.1) is generated on one of the at least two delivery lines (3.4.1).

10. The order picking system (1) according to claim 9, wherein the delivery device (3.2) is vertically offset, arranged above the stacking spot (3.1) and the piece good (W) is transferred to form a free stack(S).

11. The order picking system (1) according to claim 10, wherein the stacking device (3) comprises a lifting device (3.5), which is arranged below the delivery device (3.2) and is configured to be vertically moved in the direction of the conveyor (3.4).

12. The order picking system (1) according to claim 11, wherein the stacking device (3) comprises a stop (3.6) which is configured to position the piece good (W) delivered by the delivery device (3.2).

13. The order picking system (1) according to claim 1, wherein the order picking system (3) comprises a measuring device (3.7), which is configured to measure the height (H) of the stack(S) and/or for detecting whether a piece good (W) is located on the delivery device (3.2).

14. The order picking system (1) according to claim 1, wherein the order picking system (3) comprises a monitoring device (3.8), which is configured to monitor at least one of the layout (G) of the stack(S) in a top view and the outline (U) of the stack(S) in a side view.

15. The order picking system (1) according to claim 14, wherein the monitoring device (3.8) is configured to determine measurement data by at least one of a sensor (3.8.1) and an optical sensor, when stacking and/or when the stack(S) moves past the sensor (3.8.1).

16. The order picking system (1) according to claim 1, wherein the suspension conveyor (2.1) comprises at least one out of the following: suspended bags (2.1.1), baskets, bags, or carrying loops which are configured to convey the piece good (W) in a suspended manner.

17. The order picking system (1) according to claim 1, wherein the delivery station (2.2) is designed as a discharge device (2.2.1).

18. A method for transporting and providing piece good (W) in a stacked manner, comprising the following method steps:
a. providing a feeding device (2) comprising a suspension conveyor (2.1) and a delivery station (2.2), and providing a stacking device (3)
b. providing the piece good (W) by the suspension conveyor (2.1) and delivering the piece good (W) from the suspension conveyor (2.1) to the stacking device (3) by the delivery station (2.2);
c. stacking the conveyed piece good (W) by the stacking device (3) on the stacking spot (3.1).

19. The method according to claim 18, wherein the stacking device (3) comprises at least one delivery device (3.2) by which one piece of piece good (W) is released after the other and is transferred by gravity to form a stack(S) on the stacking spot (3.1).

20. The method according to claim 19, wherein the at least one delivery device (3.2) comprises at least one of a delivery element (3.2.1), and two or more delivery elements (3.2.1), which are configured to be moved or pivoted in order to transfer the respective piece good (W) to the stacking spot (3.1).
